(19) United States
(12) Patent Application Publication
(10) Pub. No.: US 2016/0120720 A1
(43) Pub. Date: May 5, 2016

(54) PATIENT SUPPORT COUPLED MEDICAL ACCESSORY SUPPORT

(71) Applicant: Children's Hospital Medical Center, Cincinnati, OH (US)

(72) Inventor: Russel Hirsch, Cincinnati, OH (US)

(73) Assignee: Children's Hospital Medical Center, Cincinnati, OH (US)

(21) Appl. No.: 14/919,608

(22) Filed: Oct. 21, 2015

Related U.S. Application Data
(60) Provisional application No. 62/073,629, filed on Oct. 31, 2014.

(51) Int. Cl. A61G 7/05; F16M 13/02

(52) U.S. Cl. CPC A61G 7/0503; F16M 13/022; F16M 2200/022

(57) ABSTRACT

A medical accessory support including a coupler for coupling to a patient support, a horizontal arm pivotally connected to the coupler through a locking hinge, and a vertical post supported by an adjustment mechanism providing for both a coarse adjustment and a fine adjustment.

### CROSS-REFERENCE TO RELATED APPLICATION

The present application claims priority to U.S. Provisional Patent Application Ser. No. 62/073,629, filed Oct. 31, 2014, the disclosure of which is expressly incorporated herein by reference.

### BACKGROUND AND SUMMARY

The present invention relates generally to medical accessory supports and, more particularly, to an adjustable medical accessory support configured to be coupled to a patient support, such as a hospital bed, and support accessories utilized for patient monitoring.

Individuals who may be restricted to patient supports, such as hospital beds, stretchers, etc., often require the administration of medications, and/or the use of monitoring/treatment equipment. These medical accessories are often supported by a stand coupled to the patient support. However, such accessory stands may lack flexibility in terms of positioning, may be unstable due to lightweight design or poor fitting connections, and may vertically drift when weight is applied. Additionally, such accessory stands, if adjustable, may provide for only limited vertical positioning of the medical accessories.

As such, it is desired to provide a medical accessory support including flexible arms with connecting joints for facilitating concertina movement, for use with different size patients, with lockable connecting joints for defining a variety of fixed positions, and with an adjustment mechanism for providing both coarse and fine vertical adjustments of the accessory while avoiding drift.

According to an illustrative embodiment of the present disclosure, a medical accessory support includes a patient support coupler, a first horizontal arm including a proximal end and a distal end, and a first locking hinge pivotally coupling the patient support coupler with the proximal end of the first horizontal arm. A second horizontal arm includes a proximal end and a distal end, and a second locking hinge pivotally couples the distal end of the first horizontal arm with proximal end of the second horizontal arm. A third horizontal arm includes a proximal end and a distal end, and a third locking hinge pivotally couples the distal end of the second horizontal with the proximal end of the third horizontal arm. An adjustment mechanism is supported by the distal end of the third horizontal arm, and a vertical post is supported by the adjustment mechanism. The vertical post is vertically moveable relative the adjustment mechanism and includes a lower end and an upper end. An accessory support is coupled to the upper end of the vertical post. The total length of the accessory support may be adjusted by removing at least one of the first, second and third arms, adding additional arms, and/or substituting arms with different arms having varying lengths.

According to another illustrative embodiment of the present disclosure, a medical accessory support includes a patient support coupler configured to be secured to a patient support, a first horizontal arm including a proximal end and a distal end, and a connector pivotally coupling the patient support coupler with the proximal end of the first horizontal arm. The first horizontal arm is configured to pivot about a first vertical axis defined by the connector. An adjustment mechanism is supported by the distal end of the first horizontal arm. The adjustment mechanism includes a coarse adjustment device and a fine adjustment device. A vertical post is supported by the adjustment mechanism and is vertically moveable relative to the adjustment mechanism. The vertical post includes a lower end and an upper end. An accessory support is coupled to the upper end of the vertical post.

According to a further illustrative embodiment of the present disclosure, a medical accessory support includes a bed coupler having a clamp configured to be secured to a bed rail, and a first horizontal arm including a proximal end and a distal end. A first locking hinge pivotally couples the bed coupler with the proximal end of the first horizontal arm. The first horizontal arm is configured to pivot about a first vertical axis defined by the first locking hinge. A second horizontal arm includes a proximal end and a distal end. A second locking hinge pivotally couples the distal end of the first horizontal arm with proximal end of the second horizontal arm. The second horizontal arm is configured to pivot about a second vertical axis defined by the second locking hinge. A third horizontal arm includes a proximal end and a distal end. A third locking hinge pivotally couples the distal end of the second horizontal arm with the proximal end of the third horizontal arm. The third horizontal arm is configured to pivot about a third vertical axis defined by the third locking hinge. An adjustment mechanism is supported by the distal end of the third horizontal arm and includes a coarse adjustment device and a fine adjustment device. A vertical post is supported by the adjustment mechanism and is vertically moveable relative to the adjustment mechanism. The vertical post includes a lower end and an upper end. An accessory support is coupled to the upper end of the vertical post.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is an upper perspective view of an illustrative medical accessory support of the present disclosure coupled to a bed rail;

FIG. 2 is a partially exploded view of the medical accessory support of FIG. 1;

FIG. 3 is a lower perspective view of the medical accessory support of FIG. 1;

FIG. 4 is an upper perspective view of the bed coupler of FIG. 1;

FIG. 5 is a lower perspective view of the bed coupler of FIG. 4;

FIG. 6 is an upper exploded view of the bed coupler of FIG. 4;

FIG. 7 is a lower exploded view of the bed coupler of FIG. 4;

FIG. 8 is a lower perspective view, with a partial cut-away, of the bed coupler of FIG. 4;

FIG. 9 is an upper exploded perspective view of the adjustment mechanism of FIG. 1;

FIG. 10 is a lower exploded perspective view of the adjustment mechanism of FIG. 1;

FIG. 11 is a partial longitudinal cross-sectional view of the medical accessory support of FIG. 1;

FIG. 12 is an exploded perspective view of a further illustrative coupling of the accessory table of FIG. 1;

FIG. 13 is a cross-sectional view taken along line 13-13 of FIG. 12;

FIG. 14 is a cross-sectional view taken along line 14-14 of FIG. 12;

FIG. 15 is an upper perspective view of an illustrative medical accessory support of the present disclosure coupled to an accessory mount at the head end of a patient support;

FIG. 16 is a partially exploded view of the medical accessory support of FIG. 15;

FIG. 17 is a lower perspective view of the medical accessory support of FIG. 15;

FIG. 18 is an upper exploded view of the bed coupler of FIG. 15;

FIG. 19 is a cross-sectional view taken along line 19-19 of FIG. 15;

FIG. 20 is a cross-sectional view taken along line 20-20 of FIG. 15;

FIG. 21 is an upper exploded perspective view of the adjustment mechanism of FIG. 15;

FIG. 22 is an exploded perspective view of a further illustrative coupling of the accessory table of FIG. 15;

FIG. 23 is a cross-sectional view taken along line 23-23 of FIG. 22; and

FIG. 24 is a partial longitudinal cross-sectional view of the medical accessory support of FIG. 15.

### DETAILED DESCRIPTION OF THE DRAWINGS

The embodiments of the invention described herein are not intended to be exhaustive or to limit the invention to precise forms disclosed. Rather, the embodiments elected for description have been chosen to enable one skilled in the art to practice the invention.

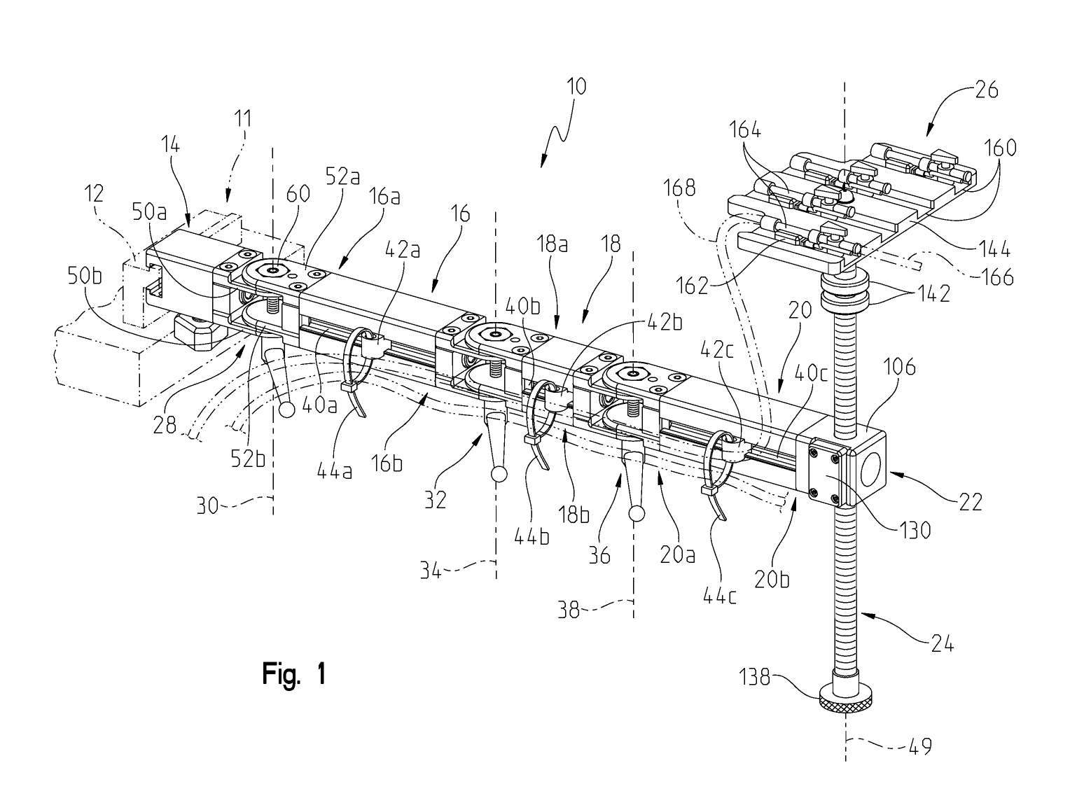

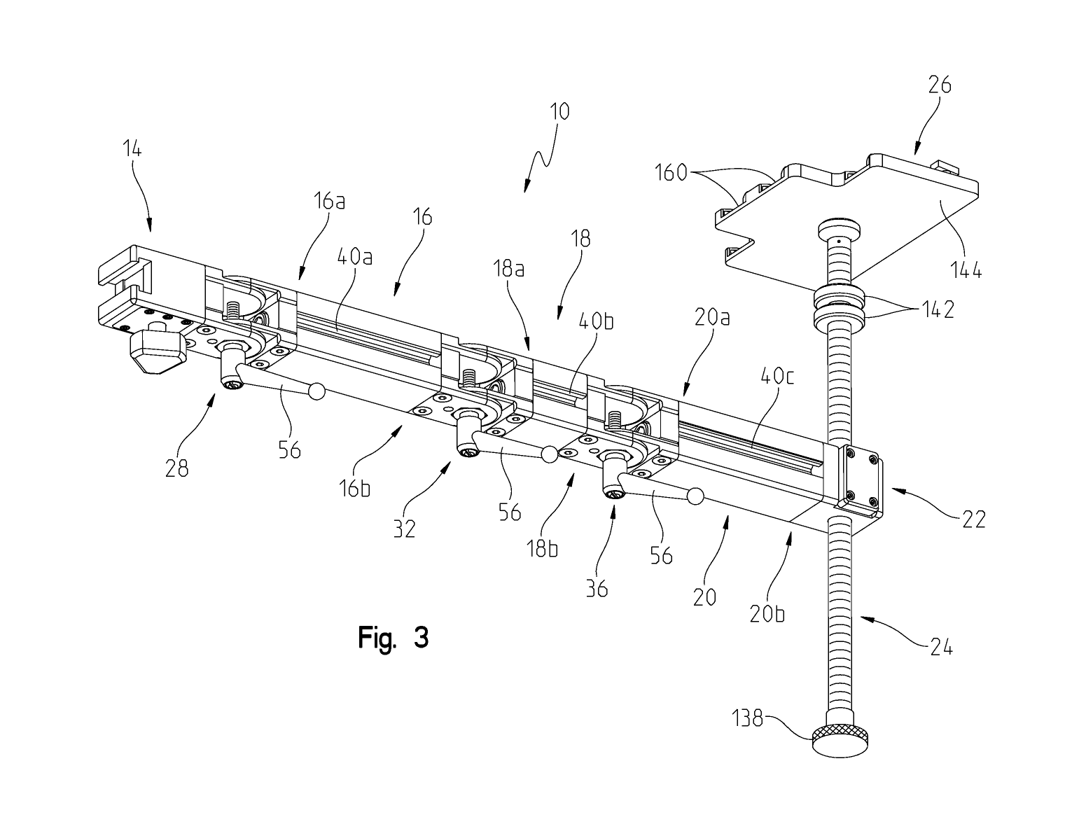

Referring initially to FIGS. 1-3, an illustrative medical accessory support 10 of the present disclosure is illustrated for use with a patient support 11 having a mounting member or rail 12 (shown in phantom in FIG. 1). In an illustrative embodiment, the patient support 11 comprises a cardiac catheterization table of conventional design where caregivers may perform monitoring of patient physiological conditions, such as hemodynamic monitoring.

The medical accessory support 10 at a proximal end includes a bed coupler 14 supporting a first horizontal arm 16, a second horizontal arm 18, and a third horizontal arm 20. An adjustment mechanism 22 is supported at a distal end of the medical accessory support 10 by the third horizontal arm 20. A threaded vertical post 24 is supported by the adjustment mechanism 22. An accessory support 26 is supported for vertical adjustment by the vertical post 24.

The first horizontal arm 16 includes a proximal end 16a and a distal end 16b. A first connector, illustratively locking hinge 28, pivotally couples the bed coupler 14 with the proximal end 16a of the first horizontal arm 16. More particularly, the first locking hinge 28 defines a first vertical axis 30 about which the first horizontal arm 16 pivots relative to the bed coupler 14. The second horizontal arm 18 includes a proximal end 18a and a distal end 18b. A second connector, illustratively locking hinge 32, pivotally couples the distal end 16b of the first horizontal arm 16 with the proximal end 18a of the second horizontal arm 18. More particularly, the second locking hinge 32 defines a second vertical axis 34 about which the second horizontal arm 18 pivots relative to the first vertical arm 16. The third horizontal arm 20 includes a proximal end 20a and a distal end 20b. A third connector, illustratively locking hinge 36, pivotally couples the distal end 18b of the second horizontal arm 18 with the proximal end 20a of the third horizontal arm 20. More particularly, the third locking hinge 36 defines a third vertical axis 38 about which the third horizontal arm 20 pivots relative to the second vertical arm 18.

Each horizontal arm 16, 18, 20 is illustratively formed of a rigid, lightweight material, such as an extruded aluminum. Longitudinally extending tracks 40a, 40b, 40c are illustratively formed in at least one side of each arm 16, 18, 20, respectively. The tracks 40a, 40b, 40c may receive mounting members associated with various medical accessories. In certain illustrative embodiments, mounts 42a, 42b, 42c are received within tracks 40a, 40b, 40c. Cable supports or ties 44a, 44b, 44c are coupled to mounts 42a, 42b, 42c and are configured to receive and support various cables, wires and/or tubes (FIG. 1).

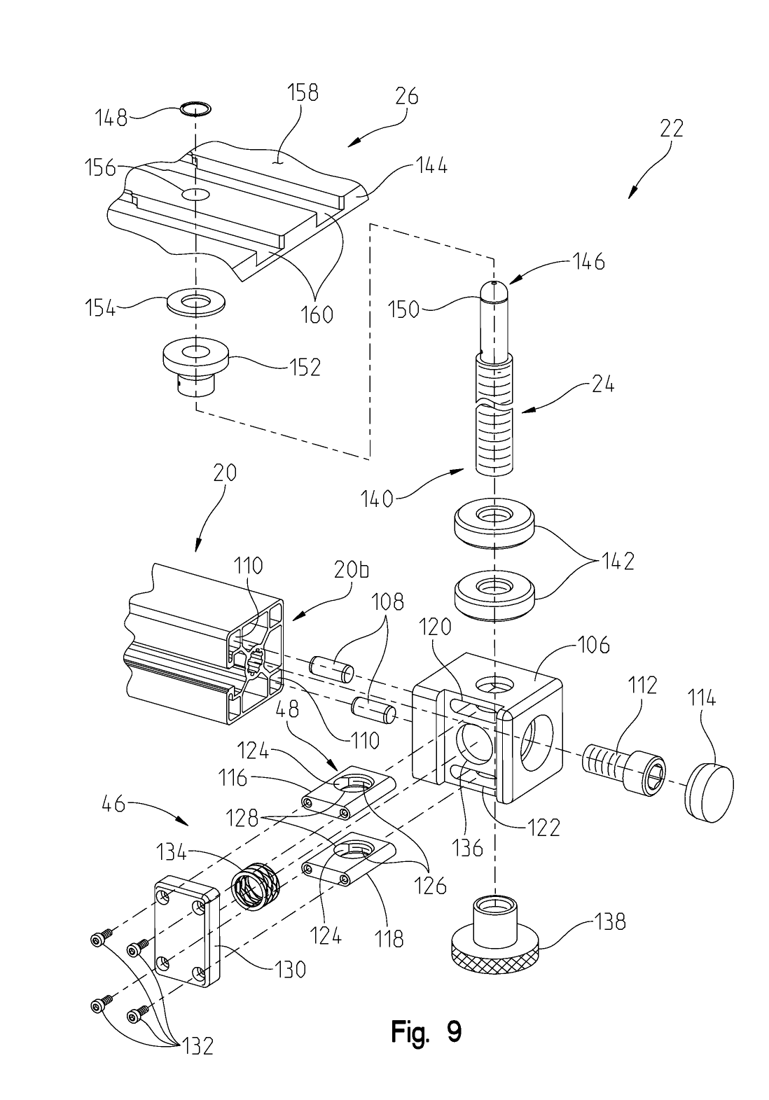

The adjustment mechanism 22 is supported by the distal end 20b of the third horizontal arm 20 and includes a coarse adjustment device 46 and a fine adjustment device 48. The vertical post 24 is supported for vertical adjustment along axis 49 by the adjustment mechanism 22. As further detailed in connection with FIGS. 9-11, the vertical post 24 is configured to freely slide within the adjustment mechanism 22 in a coarse adjustment mode (via operation of the coarse adjustment device 46), and threadably engages the adjustment mechanism 22 in a fine adjustment mode (via operation of the fine adjustment device 48).

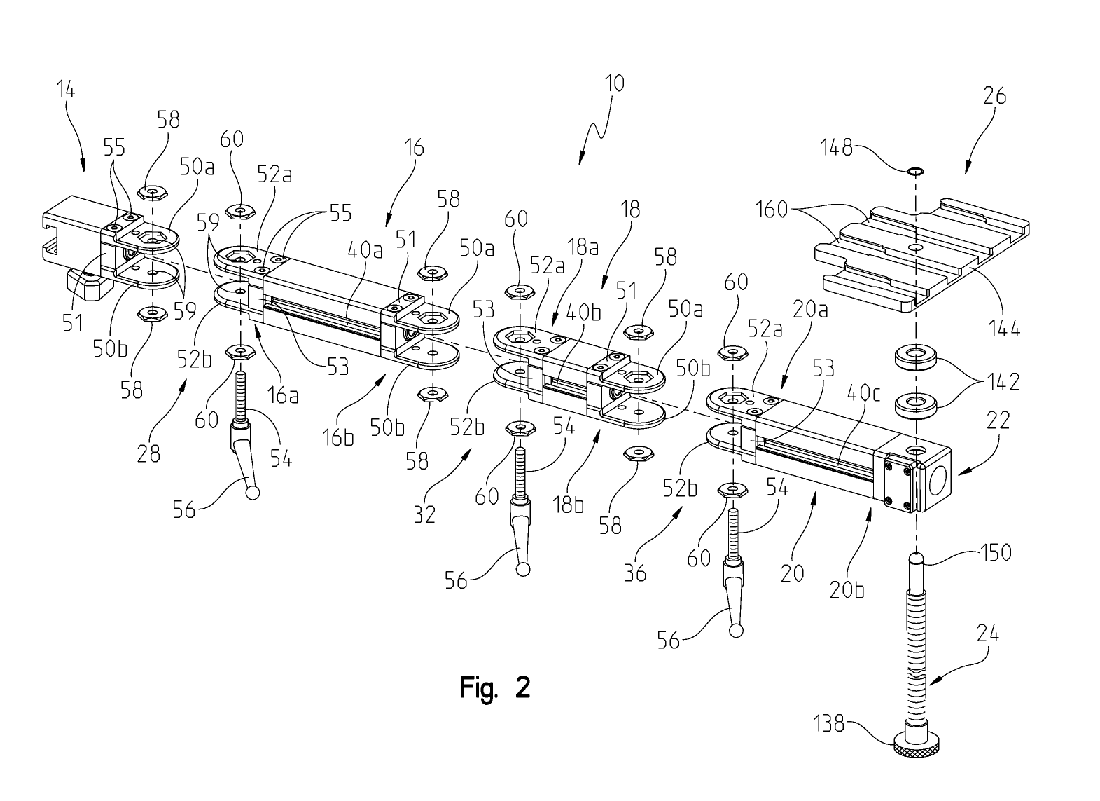

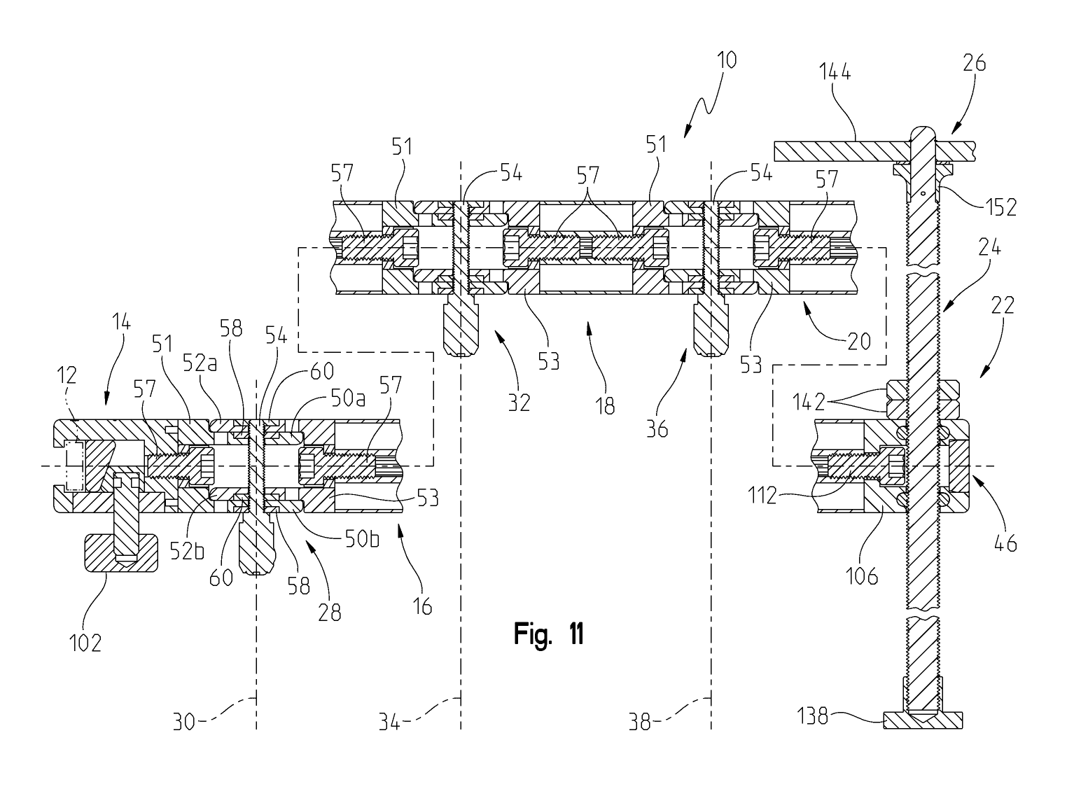

With reference to FIGS. 1 and 2, each of the locking hinges 28, 32, 36 includes proximal tabs or knuckles 50, and distal tabs or knuckles 52 positioned in a nesting arrangement. More particularly, an upper proximal knuckle 50a is positioned below an upper distal knuckle 52a, and a lower proximal knuckle 50b is positioned below a lower distal knuckle 52b. A mounting block 51 supports the proximal knuckles 50, while a mounting block 53 supports the distal knuckles 52. Knuckles 50 and 52 of mounting blocks 51 and 53 may be secured together through conventional fasteners, such as bolts 55. A fastener, such as bolt 57 (FIG. 11), illustratively secures the mounting blocks 51 and 53 to one of the bed coupler 14, and arms 16, 18 and 20.

A threaded rod 54 extends within thru-holes 59 in each of the overlapping knuckles 50 and 52 to define the first, second and third pivot axes 30, 34 and 38, respectively. A lever 56 is coupled to a lower end of each threaded rod 54 to facilitate user rotation of the respective rod 54. Threaded hex nuts 58 are supported by the proximal knuckles 50, and threaded hex nuts 60 are supported by the distal knuckles 52. The hex nuts 58, 60 threadably receive the threaded rod 54. Rotation of the lever 56 causes the hex nuts 58, 60 to compress the upper knuckles 50a, 52a and the lower knuckles 50b, 52b, thereby frictionally locking the respective hinge 28, 32, 36 in its desired position.

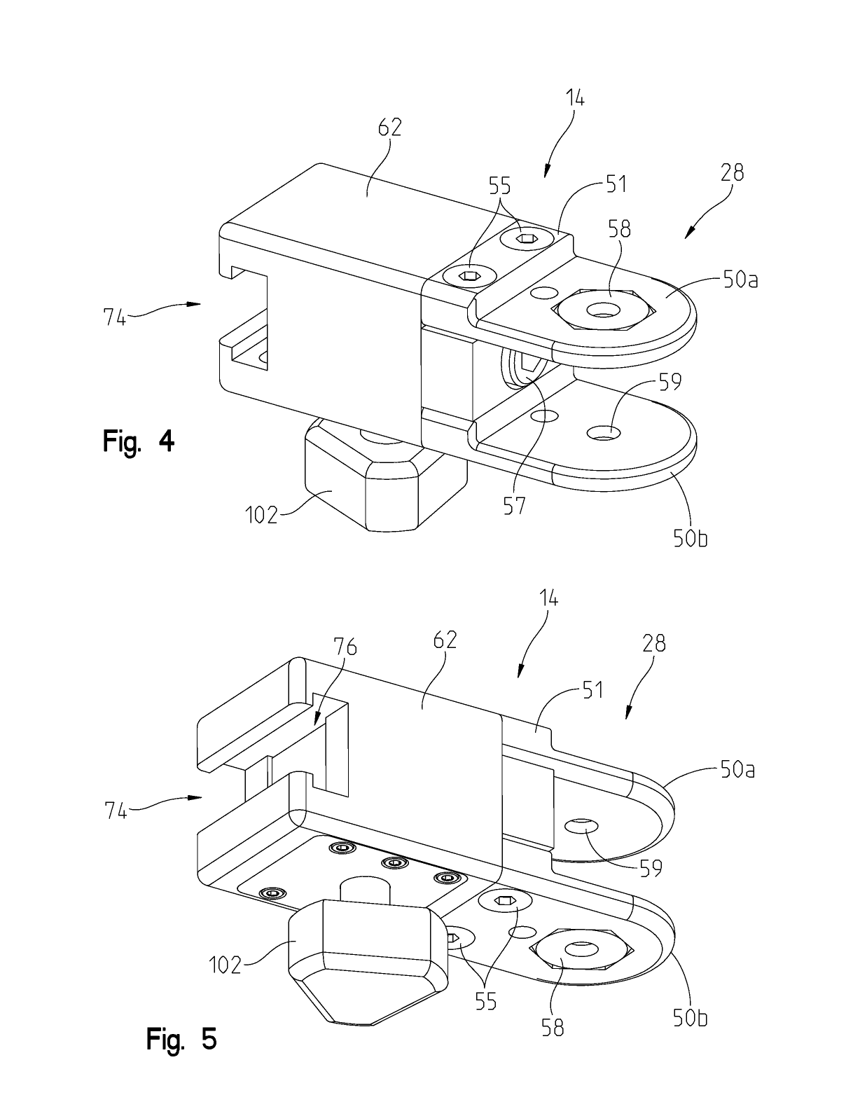

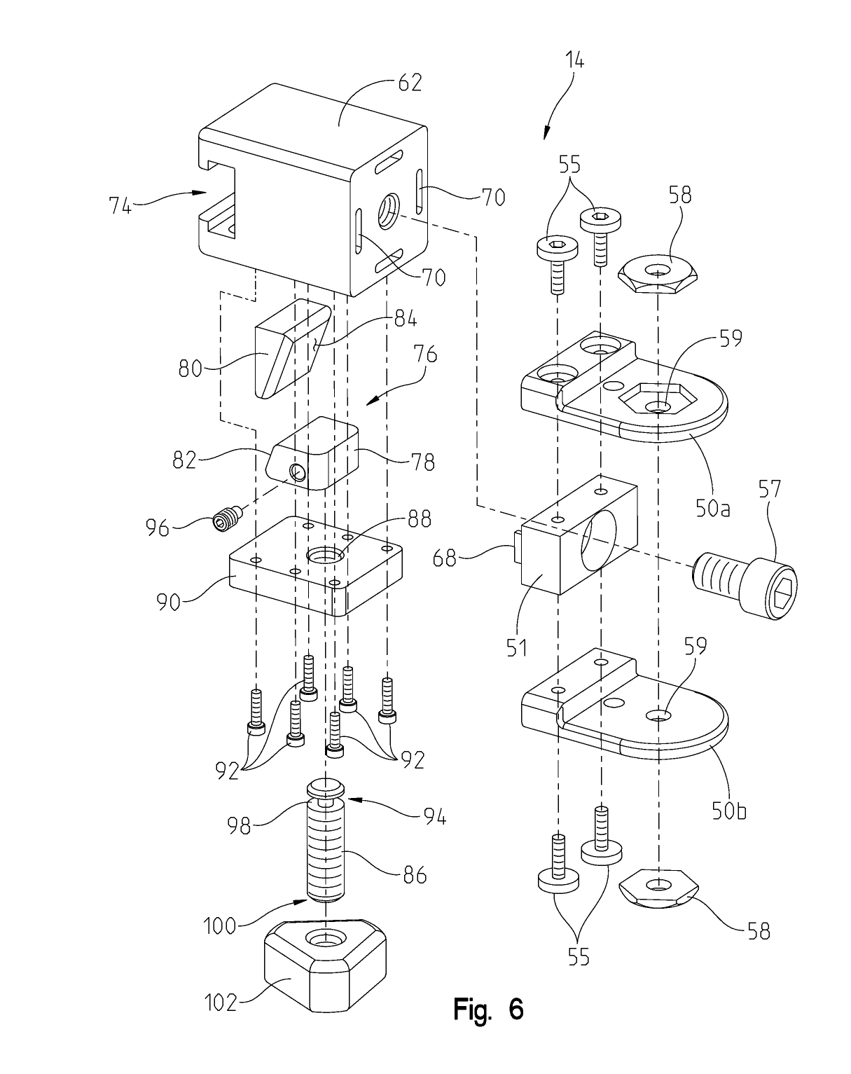

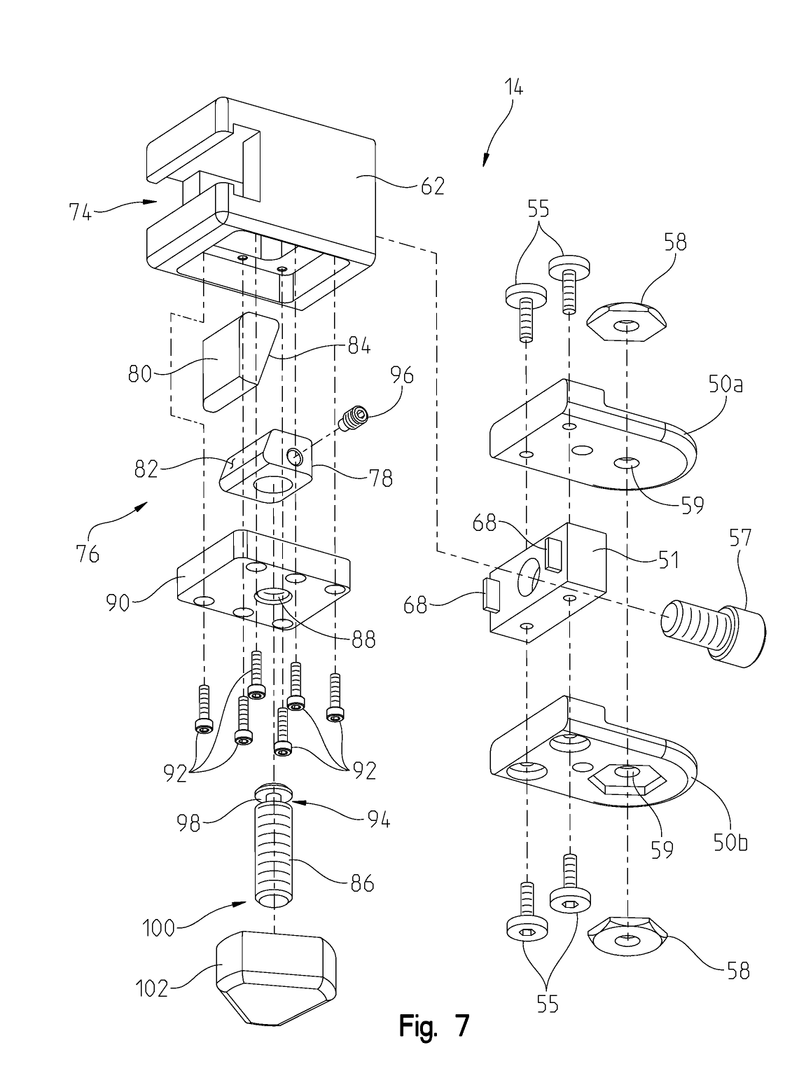

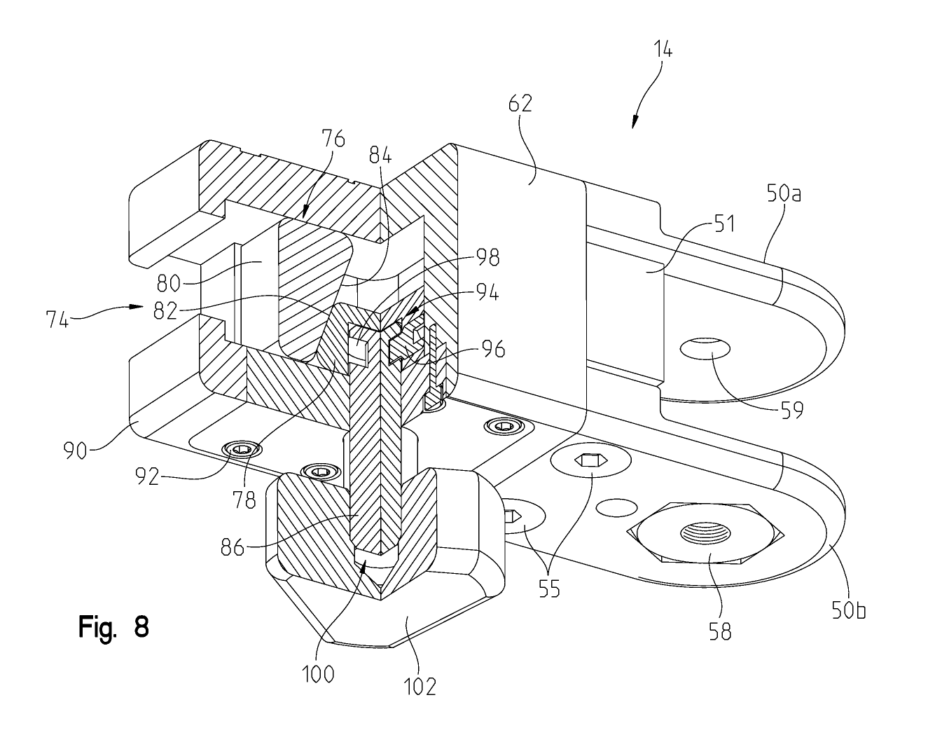

With reference to FIGS. 4-7, the bed coupler 14 includes a body 62 secured to the proximal knuckles 50 of the first locking hinge 28. More particularly, mounting block 51 is secured to the body 62 through bolt 57. Orientation tabs 68 of the mounting block 51 are received within slots 70 formed in the body 62 to properly locate the mounting block 51 relative to the body 62. Fasteners 55 secure the proximal knuckles 50 to the mounting block 51.

The body 62 defines a chamber 74 receiving a clamp assembly 76, including a drive block 78 and a locking wedge 80. The drive block 78 and the locking wedge 80 include facing inclined surfaces 82 and 84, respectively, which slidably engage each other. A threaded rod 86 is threadably received within an opening 88 of a lower plate 90. The lower plate 90 is secured to the body 62 through a plurality of fasteners, such as bolts 92.

An upper end 94 of the threaded rod 86 is illustratively secured to the drive block 78 through a set screw 96 received within an annular groove 98. A lower end 100 of the threaded rod 86 is coupled to a knob 102 to facilitate user rotation of the threaded rod 86. Rotation of the knob 102 causes the threaded rod 86 to move axially relative to the lower plate 90, thereby moving the drive block 78 relative to the locking wedge 80. As the drive block 78 is moved upwardly, the inclined surface 82 engages the inclined surface 84, thereby driving the locking wedge 80 in a proximal direction toward mounting rail 12. Similarly, as the drive block 78 is moved downwardly, the locking wedge 80 is free to move in a distal direction away from the mounting rail 12.

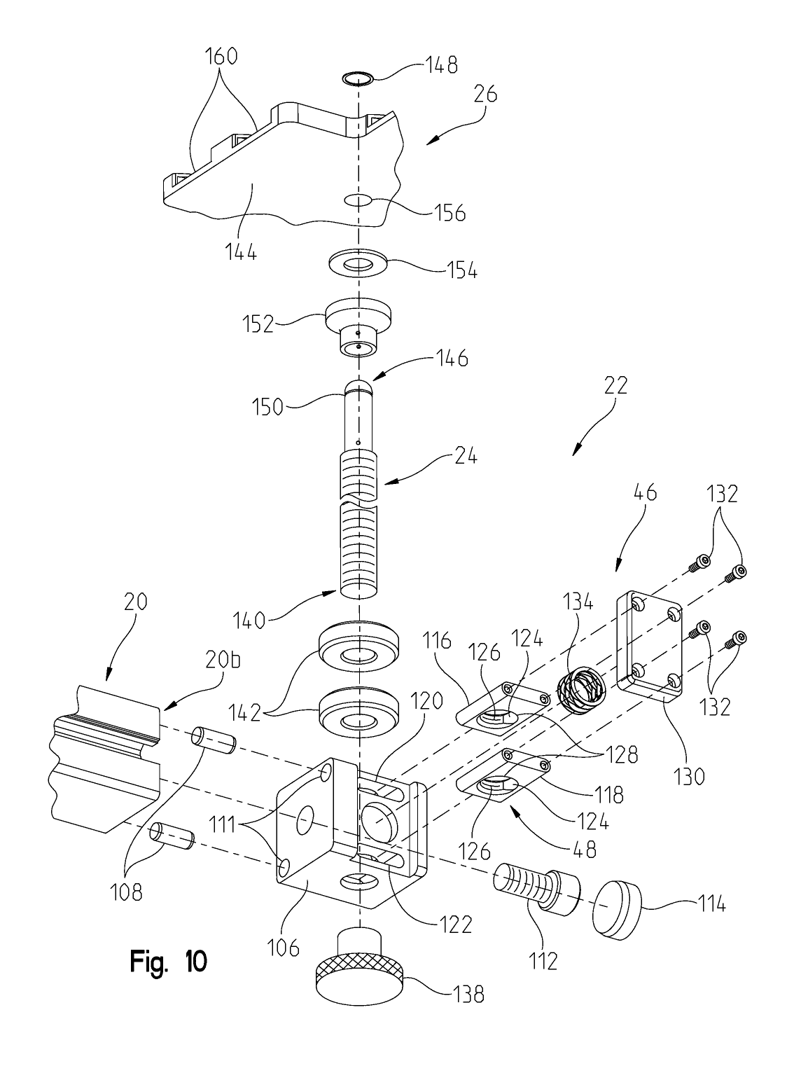

With reference now to FIGS. 9 and 10, the adjustment mechanism 22 illustratively includes a body 106 coupled to the third horizontal arm 20. A pair of pins 108 are received within recesses 110 in the distal end 20b of the third horizontal arm 20 and openings 111 in the body 106 for rotational orientation. A fastener, such as a bolt 112, secures the body 106 in position. A cap or plug 114 is received within the body 106 and covers the bolt 112.

A pair of slide members 116, 118 are slidably received within slots 120, 122 formed in the body 106. Each slide member 116, 118 includes an aperture 124 including partial threads 126 formed on a first side of the aperture 124, and a through hole 128 formed on a second side of the aperture 124. The vertical post 24 extends through the aligned apertures 124 of the slide members 116, 118. In a first or fine adjustment mode as defined by the fine adjustment device 48, each slide member 116, 118 is positioned such that the partial threads 126 engage the vertical post 24. In a second or coarse adjustment mode as defined by the coarse adjustment device 46, each slide member 116, 118 is positioned such that the partial threads 126 are disengaged from the vertical post 24. In other words, the vertical post 24 is free to move axially within the thru-hole 128 of each slide member 116, 118.

The slide members 116, 118 are secured to a button 130 by a plurality of fasteners, such as bolts 132. A spring 134 is received within a recess 136 formed in the body 106, and biases the button 130 outwardly to the fine adjustment mode. In the fine adjustment mode, the slide members 116, 118 threadably engage the threaded rod of the vertical post 24. Depressing the button 130 moves the slide members 116, 118 inwardly to the coarse adjustment mode. Depressing the button 130 causes the partial threads 126 and the slide members 116, 118 to disengage from the vertical post 24, such that the vertical post 24 may be slidably moved in a vertical direction within the thru-hole 128 of the adjustment mechanism 22. A knob 138 is secured to the lower end 140 of the vertical post 24 to facilitate user manipulation. Lock bushings 142 are threadably supported by the vertical post 24 and may define positive vertical stops.

The accessory support 26 may include an accessory tray 144 coupled to the upper end 146 of the vertical post 24 through a conventional fastener, such as a retaining clip 148 received within an annular groove 150. A bushing 152 and a washer 154 are received on the vertical post 24 and supported below the tray 144. The vertical post 24 extends through an opening 156 in the tray 144 such that the annular groove 150 and the retaining clip 148 are positioned above the tray 144. An upper surface 158 of the tray 144 may include a plurality of tracks or guides 160 to receive accessory mounts, such as conventional pressure transducer mounts 162 (FIG. 1).

The pressure transducer mounts 162 illustratively support pressure transducers 164 used in monitoring of patient physiological conditions, such as hemodynamic monitoring. Such hemodynamic monitoring may involve the continuous monitoring of the movement of blood and/or the pressures exerted in the veins, arteries, and chambers of the heart. Sense lines 166, such as cables, wires and/or tubes, may extend from the transducers 164 to the patient supported on the patient support, while output lines 168, such as cables, wires and/or tubes, may extend from the transducers 164 to monitoring equipment. Line management may be provided by the cable ties 44 and associated mounts 42. More particularly, the output lines 168 may be received within the cable ties 44 to keep the lines 168 organized and above the patient support surface.

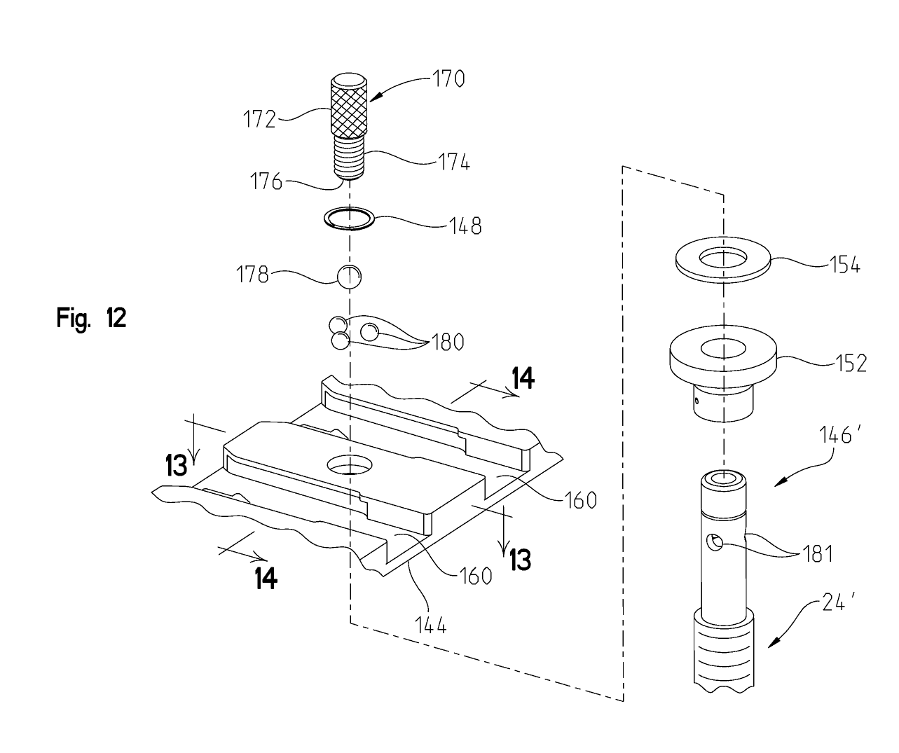

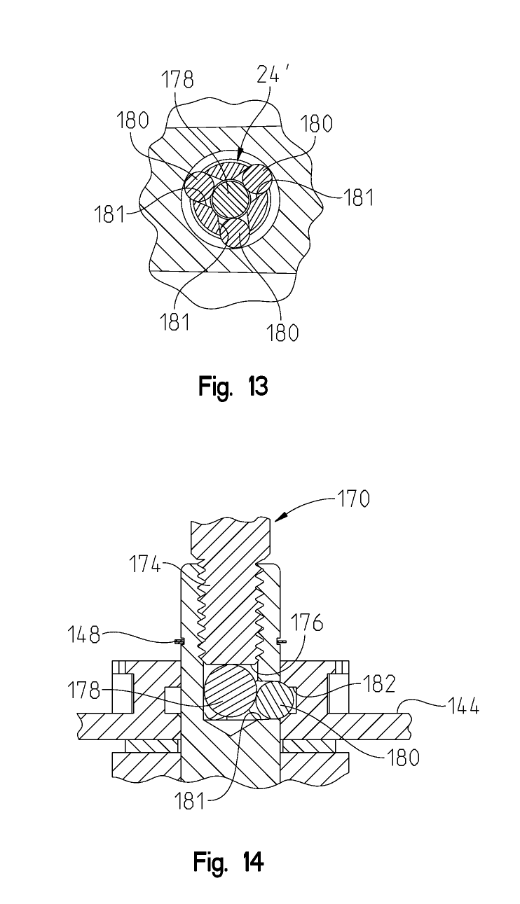

A further illustrative coupling of the accessory tray 144 to vertical post 24′ is shown in FIGS. 12-14. An adjustment member or knob 170 is threadably received within upper end 146′ of the post 24′. Locking members, illustratively balls 178 and 180 are received within the post 24′. A lower end 176 of the post 170 engages a center ball 178 supported for axial movement along axis 49. A plurality of circumferentially spaced balls 180 are supported below the center ball 178 and supported for radial movement relative to axis 49 and outwardly to extend partially through openings 181 in the post 24′. As the knob 170 is rotated downwardly, the center ball 178 engages the offset balls 180 to drive the balls 176 radially outwardly into a groove 182 defined within the tray 144, thereby securing the position of the tray 144 relative to the vertical post 24′.

As may be appreciated, the horizontal arms 16, 18, 20 may be repositioned in a concertina motion about vertical axes 30, 34, 38 defined by the locking hinges 28, 32, 36. Additionally, vertical post 24 may be vertically repositioned through the adjustment mechanism 22, thereby adjusting the accessory tray 144 and medical accessories supported thereon. For example, it may be desired in hemodynamic monitoring to maintain the pressure monitoring transducer(s) 164 vertically level with the right atrium of the heart of a patient. As such, the medical accessory mount 10 facilitates vertical adjustment of the accessory tray 144 to maintain the desired position of the transducer mounts 162 and related transducers 164. The adjustment mechanism 22 provides for a quick release through the coarse adjustment device 46, while preventing undesired slipping of the vertical post 24 and the accessory tray 144.

In certain illustrative embodiments, the accessory tray 144 may also support a leveling device, such as a laser pointer to align the transducers 164 with a desired location on the patient. For example, the laser pointer may direct visible light on a position associated with the right atrium of the patient for hemodynamic monitoring.

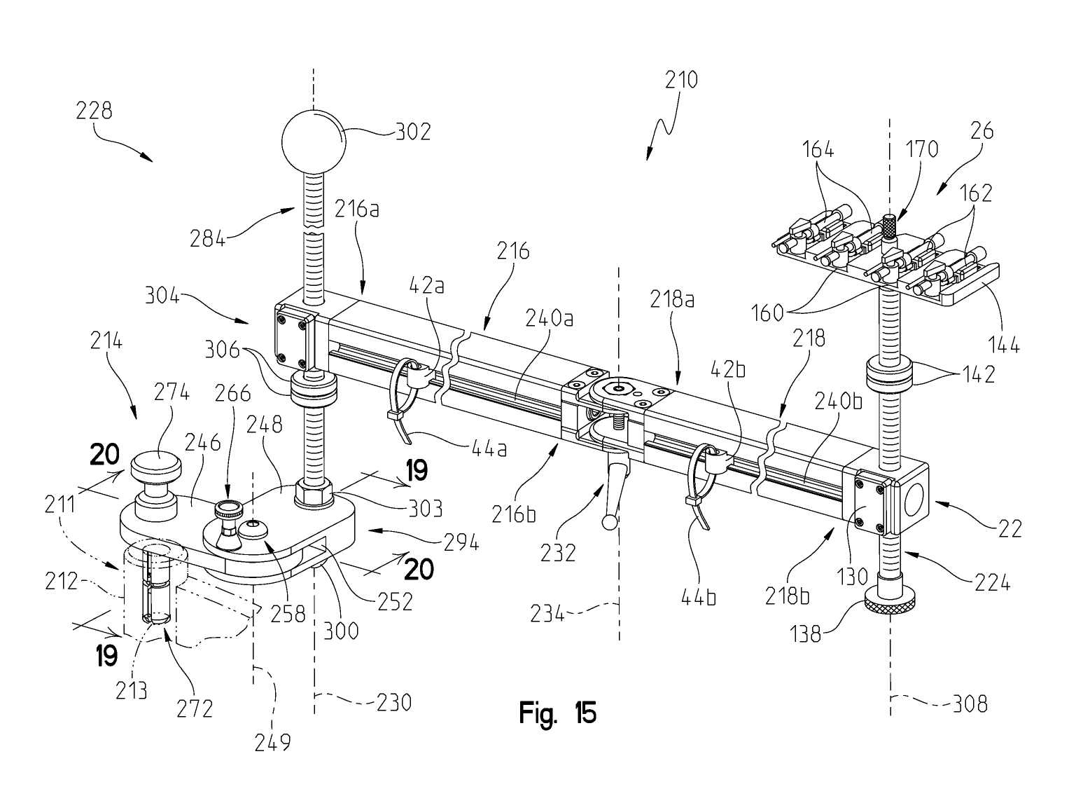

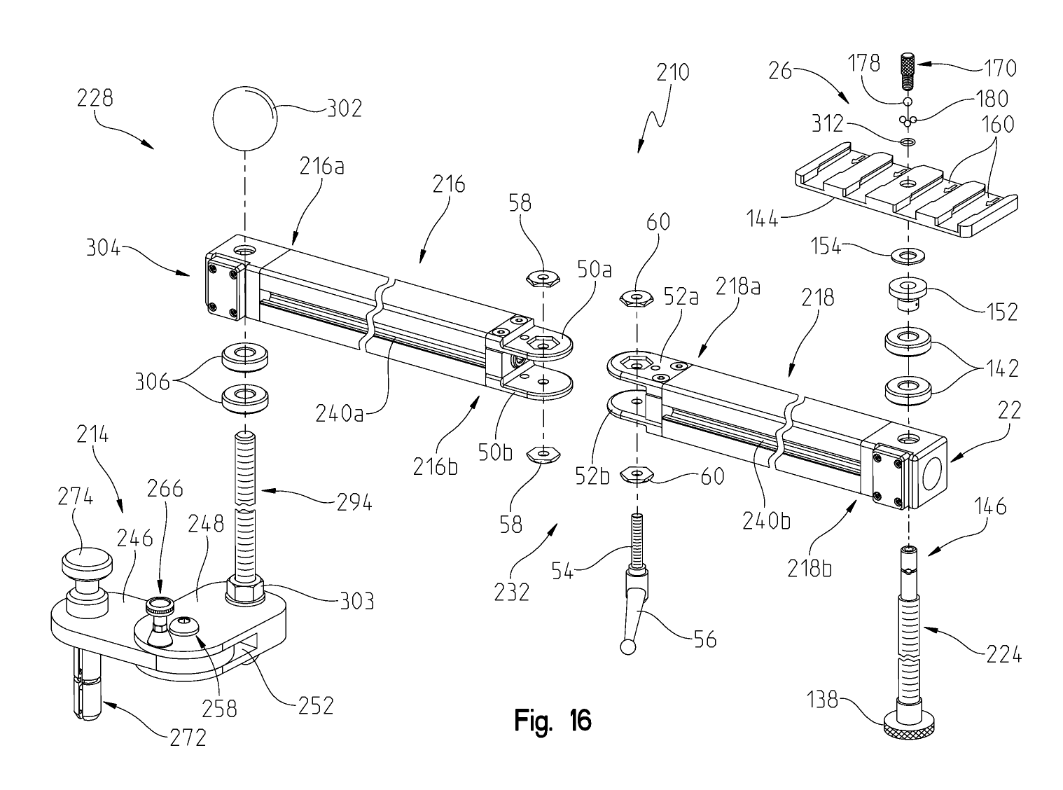

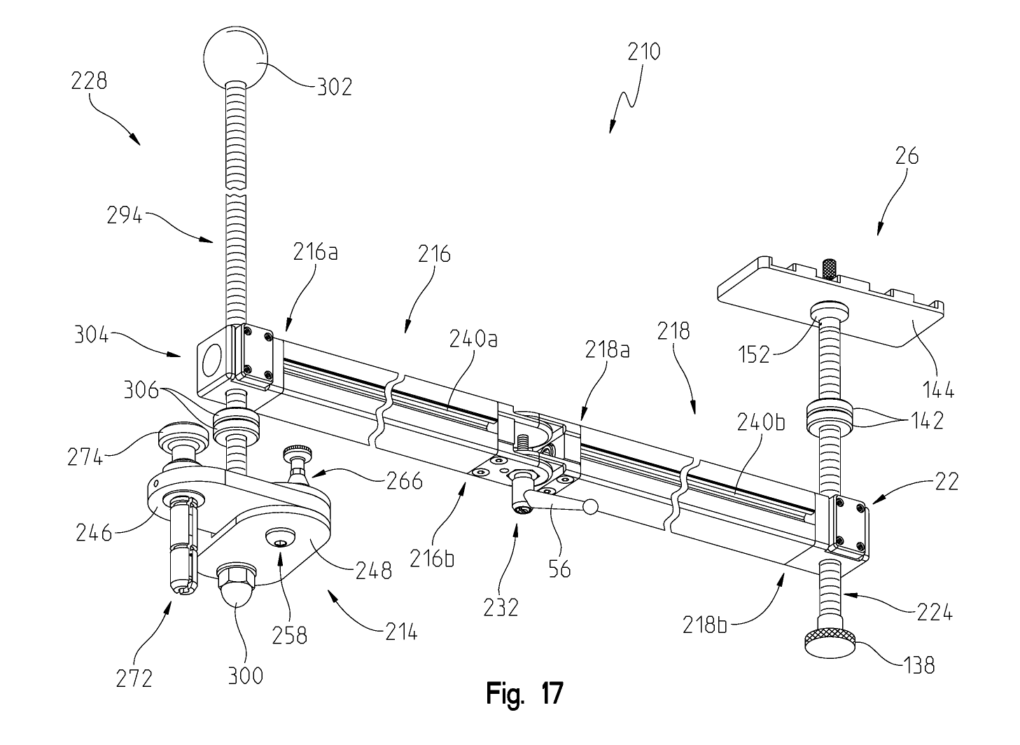

Referring now to FIGS. 15-17, a further illustrative medical accessory support 210 of the present disclosure is illustrated for use with a patient support 211 having a mounting member 212, illustratively a conventional intravenous (IV) pole support or receptacle 213 (shown in phantom in FIG. 15). In an illustrative embodiment, the patient support 211 comprises an intensive care unit (ICU) bed of conventional design where caregivers may continuously monitor physiological conditions of a patient, such as hemodynamic monitoring. Medical accessory support 210 illustratively includes many similar features as those identified above with respect to medical accessory support 10. As such, similar components are identified with like reference numbers.

The medical accessory support 210 at a proximal end includes a bed coupler 214 supporting a first horizontal arm 216 and a second horizontal arm 218. Adjustment mechanism 22 is supported at a distal end of the medical accessory support 210 by the second horizontal arm 218. A threaded vertical post 224 is supported by the adjustment mechanism 22. Accessory support 26 is supported for vertical adjustment by the vertical post 224.

The first horizontal arm 216 includes a proximal end 216a and a distal end 216b. A first connector 228 pivotally couples the bed coupler 214 with the proximal end 216a of the first horizontal arm 216. More particularly, the first connector 228 defines a first vertical axis 230 about which the first horizontal arm 216 pivots relative to the bed coupler 214. The second horizontal arm 218 includes a proximal end 218a and a distal end 218b. A second connector, illustratively a locking hinge 232, pivotally couples the distal end 216b of the first horizontal arm 216 with the proximal end 218a of the second horizontal arm 218. More particularly, the second locking hinge 232 defines a second vertical axis 234 about which the second horizontal arm 218 pivots relative to the first horizontal arm 216.

Each horizontal arm 216, 218 is illustratively formed of a rigid, lightweight material, such as an extruded aluminum. Longitudinally extending tracks 240a, 240b are illustratively formed in at least one side of each arm 216, 218, respectively. The tracks 240a, 240b may receive mounting members associated with various medical accessories (not shown). More particularly, the tracks 240a, 240b may receive mounts 42a, 42b and associated cable supports or ties 44a, 44b (FIG. 15). As detailed above, line management may be provided by the cable ties 44 and associated mounts 42. For example, output lines 168 may be received within the cable ties 44 to keep the lines 168 organized and above the patient support surface.

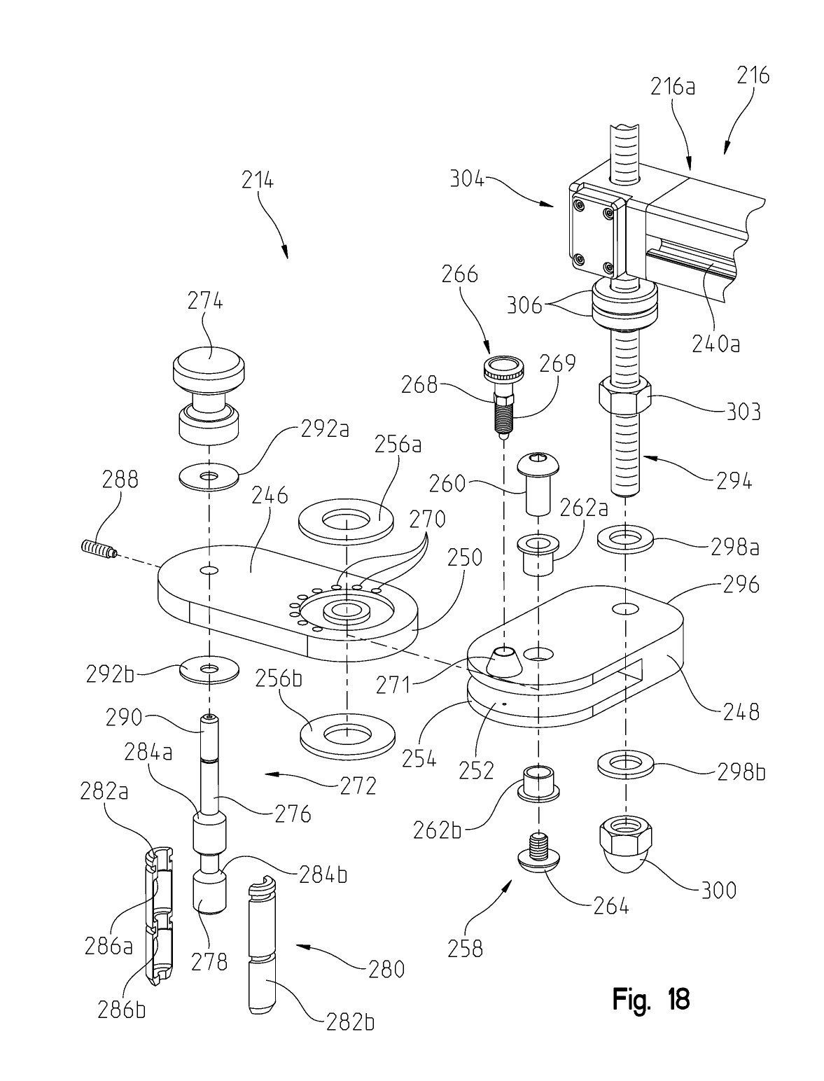

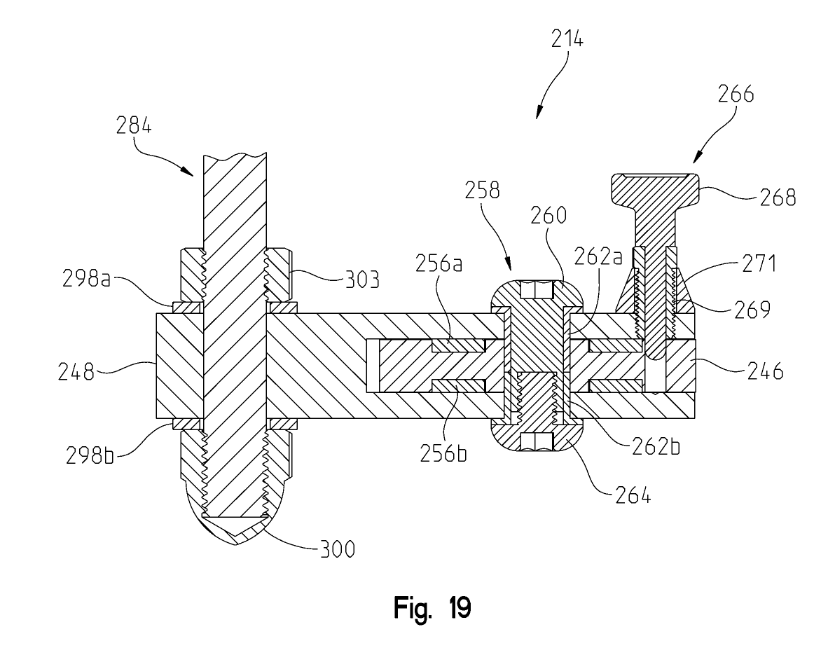

With reference to FIGS. 15 and 17-20, the bed coupler 214 includes a first member 246 configured to be coupled to the mounting member 212, and a second member 248 supported for rotation about a pivot axis 249 relative to the first member 246. More particularly, a distal end 250 of the first member 246 is received within a slot 252 formed in a proximal end 254 of the second member 248. Washers 256a and 256b are received within the slot 252 between the first and second members 246 and 248.

A pivot coupling 258 extends between the first and second members 246 and 248 and defines the pivot axis 249. The pivot coupling 258 includes a pivot pin 260 extending through bushings 262a and 262b and secured through a fastener 264.

An index device 266 is configured to define discrete angular positions of the first member 246 relative to the second member 248. The index device 246 illustratively includes a locking pin 268 supported by the second member 248 and selectively receivable within one of a plurality of circumferentially spaced apertures 270 formed in the first member 246. A biasing member, such as a spring 269, may bias the locking pin 268 downwardly toward a support member 271 and the apertures 270.

With reference to FIGS. 15, 18 and 20, an anchor 272 is supported by the first member 246 and is configured to be received within receptacle 213 of the bed 211 (FIG. 15). The anchor 272 includes a knob 274 coupled to an adjustment rod 276. A lower portion 278 of the rod 276 is received within an expandable sleeve 280. Opposing members or shells 282a and 282b expand in response to axial movement of the rod 276 to engage an inner surface of receptacle 213, thereby securing bed coupler 214 to the patient support 211. More particularly, inclined outer surfaces 284a and 284b on lower portion 278 of the rod 276 engage cooperating inner surfaces 286a and 286b, respectively, of the shells 282a and 282b. A set screw 288 engages a flat 290 to prevent rotation of the rod 276 as a user rotates the knob 274. Washers 292a and 292b are illustratively supported by the rod 276 and act as opposing bearing surfaces.

A threaded support rod 294 is supported by a distal end 296 of the second member 248. Washers 298a and 298b are illustratively coupled to the support rod 294 and act as opposing bearing surfaces. A nut 300 is coupled to a lower end of the support rod 294, while a knob 302 is coupled to an upper end of the support rod 294. Opposing nuts 300 and 303 secure the rod 294 to the second member 248.

An adjustment mechanism 304 illustratively supports the threaded rod 294. The adjustment mechanism 304 may be similar to the adjustment mechanism 22 further detailed herein. As such, the first horizontal arm 216 may be vertically adjusted along the rod 294 in either coarse or fine adjustment modes. Lock bushings 306 are threadably supported by the support rod 294 and may define positive vertical stops.

The locking hinge 232 may be of similar design as locking hinges 28, 32, 36 of medical accessory support 10. More particularly, rotation of lever 56 locks and unlocks the hinge 232 from permitting pivoting movement of the second horizontal arm 218 relative to the first horizontal arm 216.

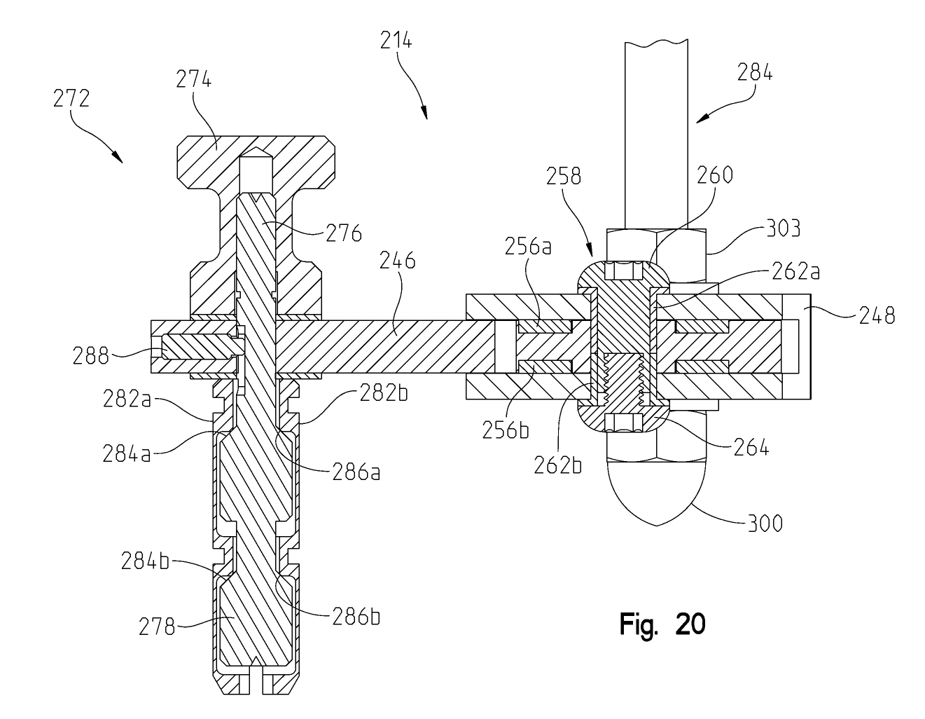

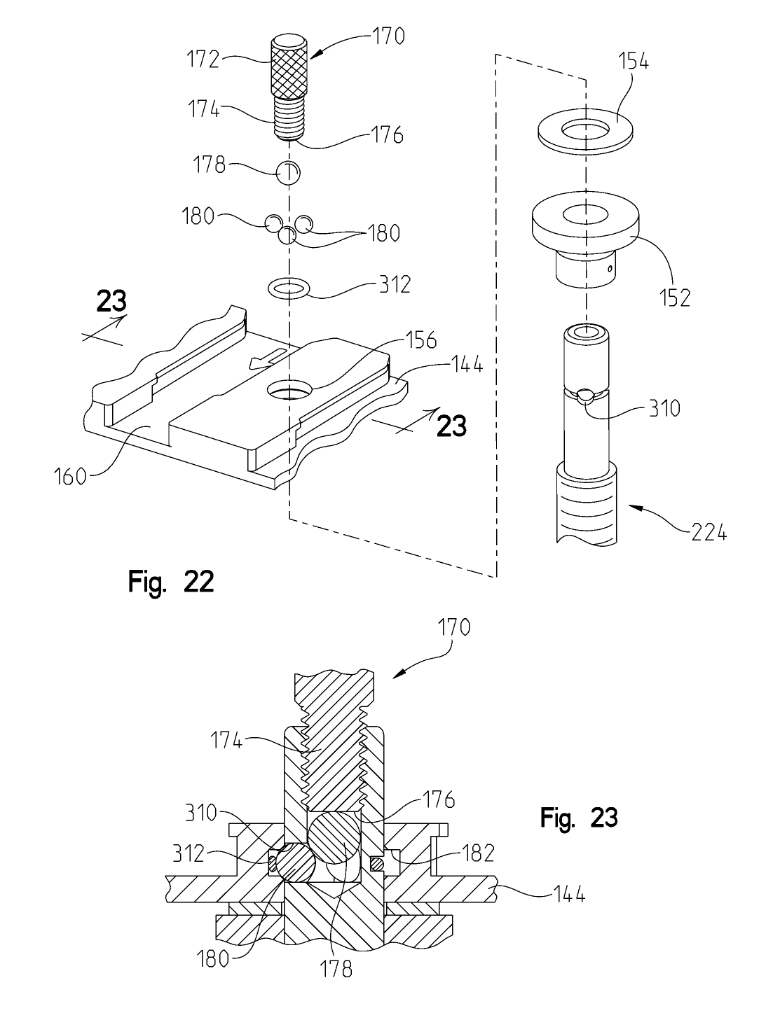

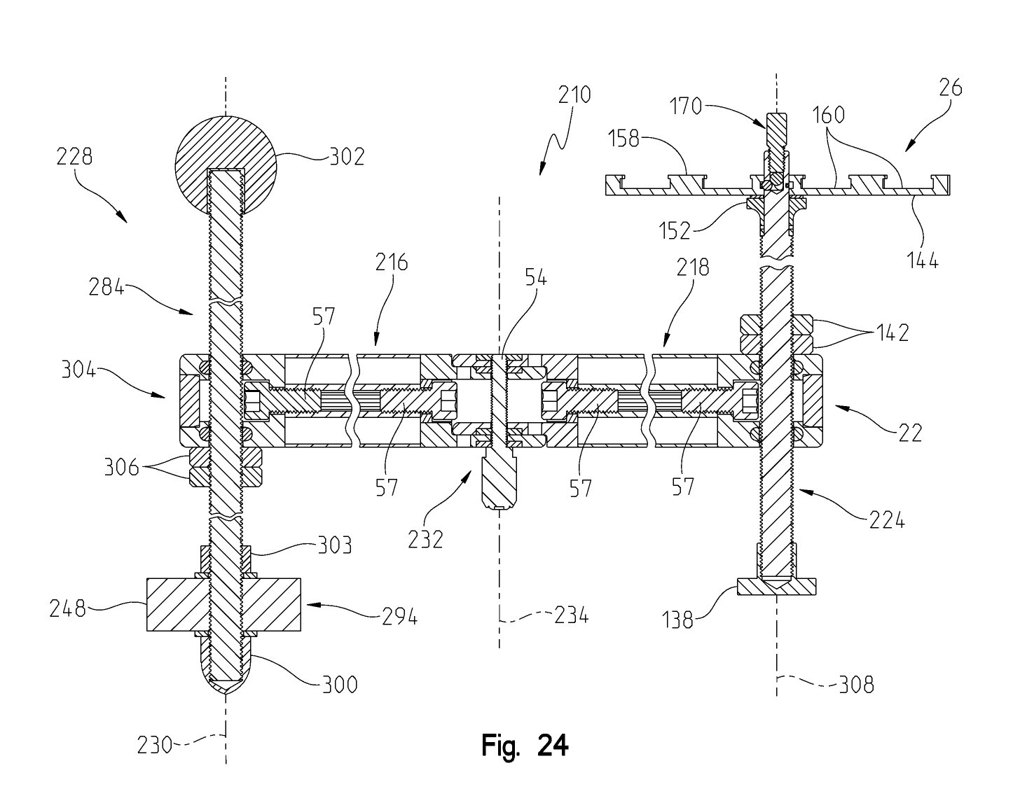

With reference now to FIGS. 20-24, the adjustment mechanism 22 of the medical accessory support 210 illustratively includes a body 106 coupled to the distal end 218b of the second horizontal arm 218. The adjustment mechanism 22 illustratively includes a coarse adjustment device 46 and a fine adjustment device 48. The vertical post 224 is supported for vertical adjustment along vertical axis 308 by the adjustment mechanism 22. The vertical post 224 is configured to freely slide within the adjustment mechanism 22 in a coarse adjustment mode (via operation of the coarse adjustment device 46), and threadably engages the adjustment mechanism 22 in a fine adjustment mode (via operation of the fine adjustment device 48). Additional details of the illustrative adjustment mechanism 22 are provided above.

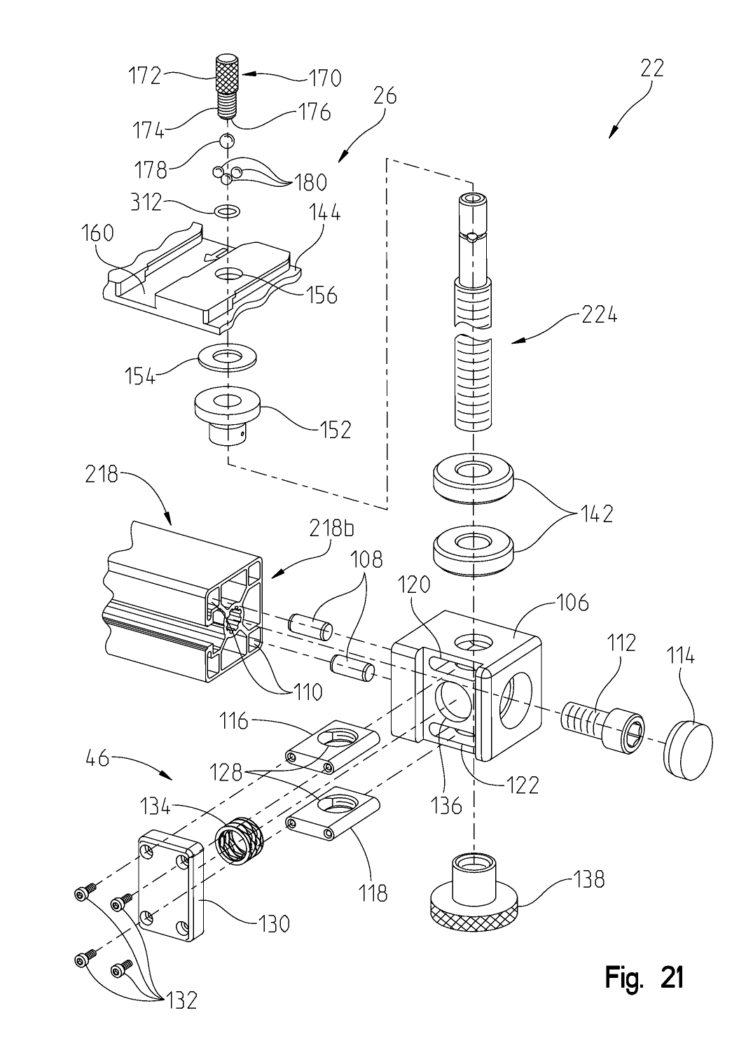

With reference to FIGS. 21-24, the accessory support 26 may include an accessory tray 144 coupled to the upper end 146 of the vertical post 224. An upper surface 158 of the tray 144 may include a plurality of tracks or guides 160 to receive accessory mounts, such as conventional pressure transducer mounts 162 coupled to transducers 164.

An adjustment member or knob 170 is threadably received within upper end 296 of the post 224. Locking members, illustratively balls 178 and 180 are received within the post 224. A lower end 176 of the post 170 engages a center ball 178 supported for axial movement along axis 308. A plurality of circumferentially spaced balls 180 are supported below the center ball 178 and supported for radial movement relative to vertical axis 308 and outwardly to extend partially through openings 310 in the post 224. As the knob 170 is rotated downwardly, the center ball 178 engages the offset balls 180 to drive the balls 176 radially outwardly into an elastomeric o-ring 312 received within a groove 182 defined in the tray 144, thereby securing the position of the tray 144 relative to the vertical post 224.

It should be appreciated that other illustrative embodiments and variations of the accessory mounts 10 and 210 may be utilized based upon the associated patient support, including mounting structure and desired positioning of the supported patient monitoring equipment. For example, the patient support coupler of the accessory mount 10, 210 may be configured for use with various patient supports, such as operating room (OR) tables. Additionally, the number and configuration of the horizontal arms 16, 18, 20 and 216, 218 may vary.

Although the invention has been described in detailed with reference to preferred embodiments, variations and modifications exist within the spirit and scope of the invention as described and defined in the following claims.

1. A medical accessory support comprising:
a patient support coupler;
a first horizontal arm including a proximal end and a distal end;
a first locking hinge pivotally coupling the patient support coupler with the proximal end of the first horizontal arm;
a second horizontal arm including a proximal end and a distal end;
a second locking hinge pivotally coupling the distal end of the first horizontal arm with the proximal end of the second horizontal arm;
a third horizontal arm including a proximal end and a distal end;
a third locking hinge pivotally coupling the distal end of the second horizontal arm with the proximal end of the third horizontal arm;
an adjustment mechanism supported by the distal end of the third horizontal arm;
a vertical post supported by the adjustment mechanism and vertically movable relative to the adjustment mechanism, the vertical post including a lower end and an upper end; and
an accessory support coupled to the upper end of the vertical post.

2. The medical accessory support of claim 1, wherein the accessory support comprises a transducer tray.

3. The medical accessory support of claim 1, wherein the adjustment mechanism includes a coarse adjustment device and a fine adjustment device.

4. The medical accessory support of claim 3, wherein the coarse adjustment device includes a push button quick release mechanism.

5. The medical accessory support of claim 4, wherein the fine adjustment device includes a threaded coupling between the adjustment mechanism and the vertical post.

6. The medical accessory support of claim 1, wherein each of the first locking hinge, the second locking hinge and the third locking hinge includes a lever and a friction member operably coupled to the lever.

7. The medical accessory support of claim 1, wherein the first horizontal arm is configured to pivot about a first vertical axis defined by the first locking hinge, the second horizontal arm is configured to pivot about a second vertical axis defined by the second locking hinge, and the third horizontal arm is configured to pivot about a third vertical axis defined by the third locking hinge.

8. The medical accessory support of claim 1, wherein the patient support coupler includes a clamp configured to be secured to a bed rail.

9. A medical accessory support comprising:
a patient support coupler configured to be secured to a patient support;
a first horizontal arm including a proximal end and a distal end;
a connector pivotally coupling the patient support coupler with the proximal end of the first horizontal arm, the first horizontal arm being configured to pivot about a first vertical axis defined by the connector;
an adjustment mechanism supported by the distal end of the first horizontal arm, the adjustment mechanism including a coarse adjustment device and a fine adjustment device;
a vertical post supported by the adjustment mechanism and vertically movable relative to the adjustment mechanism, the vertical post including a lower end and an upper end; and
an accessory support coupled to the upper end of the vertical post.

10. The medical accessory support of claim 9, wherein the connector comprises a first locking hinge.

11. The medical accessory support of claim 10, further comprising a second horizontal arm, and a second locking hinge pivotally coupling the first horizontal arm with the second horizontal arm.

12. The medical accessory support of claim 11, further comprising a third horizontal arm, and a third locking hinge pivotally coupling the second horizontal arm with the third horizontal arm.

13. The medical accessory support of claim 12, wherein the first horizontal arm is configured to pivot about a first vertical axis defined by the first locking hinge, the second horizontal arm is configured to pivot about a second vertical axis defined by the second locking hinge, and the third horizontal arm is configured to pivot about a third vertical axis defined by the third locking hinge.

14. The medical accessory support of claim 10, wherein the accessory support comprises a transducer tray.

15. The medical accessory support of claim 10, wherein the coarse adjustment device includes a push button quick release mechanism.

16. The medical accessory support of claim 15, wherein the fine adjustment device includes a threaded coupling between the adjustment mechanism and the vertical post.

17. The medical accessory support of claim 10, wherein the patient support coupler includes a clamp configured to be secured to a bed rail.

18. The medical accessory support of claim 10, wherein the patient support coupler includes a vertical post including an expandable sleeve configured to be received within an intravenous post receptacle.

19. The medical accessory support of claim 18, wherein the patient support coupler further includes a rotatable knob configured to rotate the vertical post for expanding the sleeve.

20. The medical accessory support of claim 10, wherein the first locking hinge includes a lever and a friction member operably coupled to the lever.

21. A medical accessory support comprising:
a bed coupler including a clamp configured to be secured to a bed rail;
a first horizontal arm including a proximal end and a distal end;
a first locking hinge pivotally coupling the bed coupler with the proximal end of the first horizontal arm, the first horizontal arm being configured to pivot about a first vertical axis defined by the first locking hinge;
a second horizontal arm including a proximal end and a distal end;
a second locking hinge pivotally coupling the distal end of the first horizontal arm with the proximal end of the second horizontal arm, the second horizontal arm being configured to pivot about a second vertical axis defined by the second locking hinge;
a third horizontal arm including a proximal end and a distal end;
a third locking hinge pivotally coupling the distal end of the second horizontal arm with the proximal end of the third horizontal arm, the third horizontal arm being configured to pivot about a third vertical axis defined by the third locking hinge;
an adjustment mechanism supported by the distal end of the third horizontal arm, the adjustment mechanism including a coarse adjustment device and a fine adjustment device;
a vertical post supported by the adjustment mechanism and vertically movable relative to the adjustment mechanism, the vertical post including a lower end and an upper end; and
an accessory support coupled to the upper end of the vertical post.
